(19) United States
(12) Patent Application Publication
(10) Pub. No.: US 2025/0046289 A1
(43) Pub. Date: Feb. 6, 2025

(54) SOUND BARRIER SYSTEM

(71) Applicant: King Chung Yiu, Tsing Yi (HK)

(72) Inventor: King Chung Yiu, Tsing Yi (HK)

(21) Appl. No.: 18/760,605

(22) Filed: Jul. 1, 2024

Related U.S. Application Data
(60) Provisional application No. 63/529,778, filed on Jul. 31, 2023.

(51) Int. Cl. G10K 11/168; B32B 1/00; B32B 3/12; B32B 3/26; B32B 5/02; B32B 5/26; B32B 15/14

(52) U.S. Cl. CPC G10K 11/168; B32B 1/00; B32B 3/12; B32B 3/266; B32B 5/02; B32B 5/26; B32B 15/14; B32B 2262/101; B32B 2262/108; B32B 2307/102; B32B 2307/7376

(57) ABSTRACT

A sound barrier system, which includes three or more poles aligned substantially along a line. Every two adjacent ones of the three or more poles are separated from each other by a distance in the range of 0.4 m to 2 m, in order to reduce wind loads on the sound barrier system. By having significant gaps between the barrier systems, wind loads on the barrier systems are reduced and foundation load requirements are also reduced.

### CROSS REFERENCE TO RELATED APPLICATION

This application claims the benefit of U.S. Patent Application Ser. No. 63/529,778, filed Jul. 31, 2023, the disclosure of which is incorporated herein by reference in its entirety. To the extent appropriate, a claim for priority is made to the above disclosed application.

### FIELD OF INVENTION

This invention relates to outdoor noise barriers, for example those installed near railway lines, highways, and aircraft runways.

### BACKGROUND OF INVENTION

Noise pollution is a major problem in urban areas and can negatively impact human health and well-being. Various noise barrier systems have been developed to reduce noise pollution and to protect high-rise buildings near busy roads and railway lines. However, conventional noise barriers require a large foundation to withstand wind load, which is expensive and sometimes impractical.

For example, when installing a noise barrier on a viaduct, it is difficult to expand the viaduct foundation to accommodate the additional wind load from the barrier. Without enlarging the viaduct foundation, the size of the additional barrier must be significantly smaller than the longitudinal cross-sectional area of the viaduct. Therefore, retrofitting viaducts with high noise barriers is usually impractical.

In addition, traditional sound barriers are usually shaped in walls/screens, which impede airflow in adjacent areas and can accumulate airborne pollutants around the screen. As a result, air pollutants take longer to diffuse out.

### SUMMARY OF INVENTION

There is thus a need to provide an improved sound barrier system in order to overcome or at least alleviate the above problems. In particular, there is a need to increase the height of the noise barrier without increasing the wind load on the noise barrier and the corresponding foundation requirements. Also, there is a need to provide an acoustic barrier that is less obstructive to the passage of airflow.

Accordingly, the present invention, in one aspect, provides a sound barrier system, which includes three or more poles aligned substantially along a line. Every two adjacent ones of the three or more poles are separated from each other by a distance in the range of 0.4 m to 2 m, in order to reduce wind loads on the sound barrier system.

In some embodiments, the three or more poles each extend along a vertical direction.

In some embodiments, the three or more poles each has a length of more than 4 m.

In some embodiments, the sound barrier system further contains a sound barrier screen on top of which the three or more poles are mounted.

In some embodiments, an overall height of the sound barrier screen and the three or more poles is more than 4 m.

In some embodiments, at least one of the three or more poles comprises a pole body, and a plurality of ribs formed with or connected to a surface of the pole body, creating air cavities between the adjacent ribs.

In some embodiments, the plurality of ribs each has a surface density of at least 4 kg/m².

In some embodiments, the pole body has a circular cross-sectional shape. The plurality of ribs is separated from each other evenly by an angular cavity.

In some embodiments, at least some of the angular cavities are filled by a sound absorbing material.

In some embodiments, the at least one of the three or more poles further contains a layer of sound-absorbing material which encloses the plurality of ribs.

In some embodiments, the layer of sound-absorbing material has a thickness of more than 40 mm.

In some embodiments, the at least one of the three or more poles further contains a perforated metal sheet which encloses the plurality of ribs.

In some embodiments, a hole in the perforated metal sheet is covered by an acoustic transparent membrane configured at an interior surface of the perforated metal sheet.

In some embodiments, at least one of the three or more poles has a quadrilateral cross-sectional shape.

In some embodiments, the distance between two adjacent poles is in the range of 0.6 m-1.2 m.

In some embodiments, a horizontal pole is located above the three or more poles, and top ends of the poles are connected to the horizontal pole.

One can see that embodiments of the invention therefore provide sound barrier systems that are based on pole structures. By configuring significant gaps between the poles in the barrier systems, wind loads on the barrier systems are reduced and foundation load requirements are also reduced. Under the same foundation load, the construction height of the barrier systems can be two to three times that of traditional screen/wall barriers, providing noise protection for the upper floors of high-rise buildings. In addition, reduced wind load on the barrier system makes retrofitting viaducts with high noise barriers practical and cost-effective.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1a shows the perspective view of a sound barrier system according to a first embodiment of the invention.

FIG. 1b is a top view of the sound barrier system in FIG. 1a.

FIG. 2 is a top view of a sound barrier system according to another embodiment of the invention.

FIG. 3 shows the perspective view of a sound barrier system according to a further embodiment of the invention.

FIG. 4a shows the cross-sectional view of a pole in a sound barrier system according to a further embodiment of the invention.

FIG. 4b shows the cross-sectional view of a pole in a sound barrier system according to a further embodiment of the invention.

FIG. 4c shows the cross-sectional view of a pole in a sound barrier system according to a further embodiment of the invention.

FIG. 5a illustrates the calculation of noise reduction levels for a sound barrier system with round poles according to an embodiment of the invention.

FIG. 5b illustrates the calculation of noise reduction levels for a sound barrier system with square poles according to an embodiment of the invention.

FIG. 6 illustrates the calculation of wind load drag force for a sound barrier system with round poles according to an embodiment of the invention, in comparison to a traditional noise barrier screen.

FIG. 7 shows the perspective view of a sound barrier system according to a further embodiment of the invention.

### DETAILED DESCRIPTION

Various embodiments of the invention provide sound barrier systems using a plurality of poles with significant gaps between the poles to reduce wind loads on the barrier structure. Such sound barrier systems for example can be installed on viaduct structures, where the allowable wind load on the noise barrier is limited by the designed maximum turning moment of the viaduct foundation. The sound barrier systems according to embodiments of the invention are suitable for protecting tall buildings adjacent to busy roads and railway lines, where conventional sound barriers may not be high enough to protect the top floors of tall buildings from traffic noise. For example, conventional noise barriers may provide 10 to 20 dB (A) of noise reduction for the lower floors of residential buildings adjacent to busy roads and railway lines, but they fail to protect the top floors due to insufficient noise barrier height.

Some embodiments of the invention allow for a higher noise barrier, while providing a noise reduction of 3 to 10 dB (A)). It is worth noting that the upper floors of tall buildings are farther from noise sources than the lower floors. In many cases, the upper floors of high-rise buildings only need to reduce the noise by 3 to 10 dB (A) to meet the noise standards.

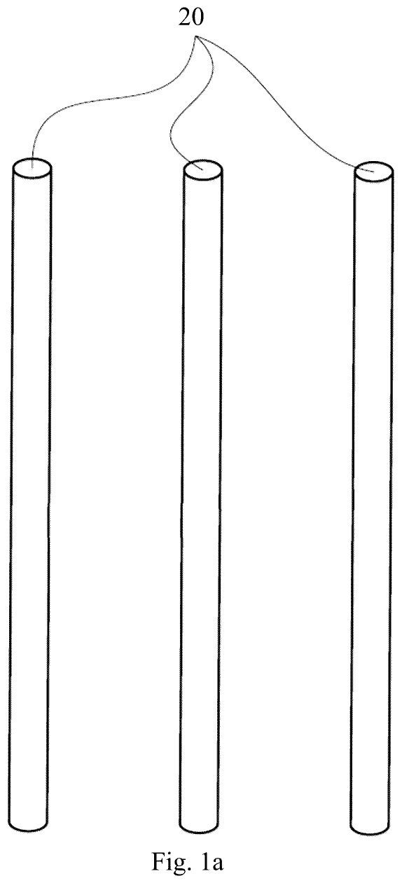

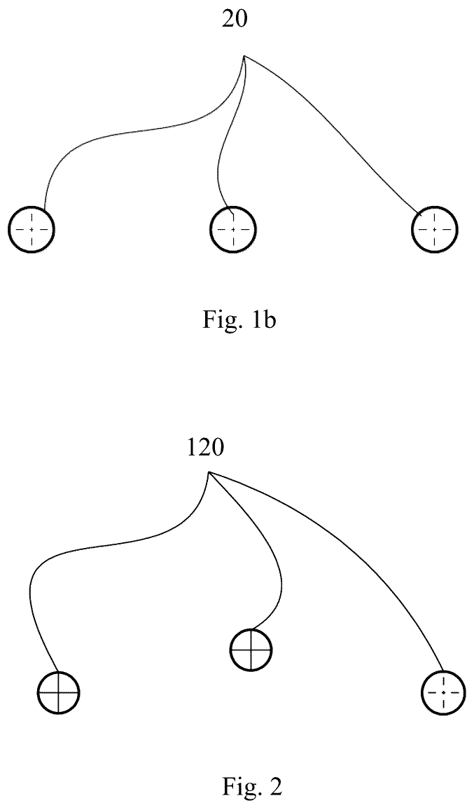

Turning to FIGS. 1a and 1b, which show a sound barrier system according to a first embodiment of the invention. The sound barrier system as illustrated has three poles 20, which are separated from each other by a distance. Each pole 20 has a circular cross-section, and extend along a vertical direction as the poles 20 are installed on a base structure such as a viaduct foundation (not shown). The three poles 20 have identical lengths, and an overall height of the sound barrier system equals to the length of a single pole 20. The three poles 20 are aligned with each other along a straight line, as best shown in FIG. 1b.

In a specific implementation, the distance between every two adjacent poles 20 is equal to or larger than 0.4 m. In another specific implementation, the distance between every two adjacent poles 20 is smaller than 2 m. In a further specific implementation, the distance between every two adjacent poles 20 is between 0.4 m and 2 m. In a further specific implementation, the distance between every two adjacent poles 20 is 0.6 m and 0.8 m. In a further specific implementation, the length of each pole 20, and thus the overall height of the sound barrier system, is more than 4 m. In a further specific implementation, the diameter of each pole 20 is larger than 0.4 m.

Turning to FIG. 2, a sound barrier system similar to that in FIGS. 1a-1b also contains three poles 120. However, what is different between the sound barrier systems in FIGS. 1a-1b, and in FIG. 2, is that the three poles 120 shown in FIG. 2 are not precisely aligned along a straight line. Rather, it can be seen that the pole 120 in the middle is offset as compared to the other two poles 120, and the three poles together define a triangular shape in a top view of the sound barrier system.

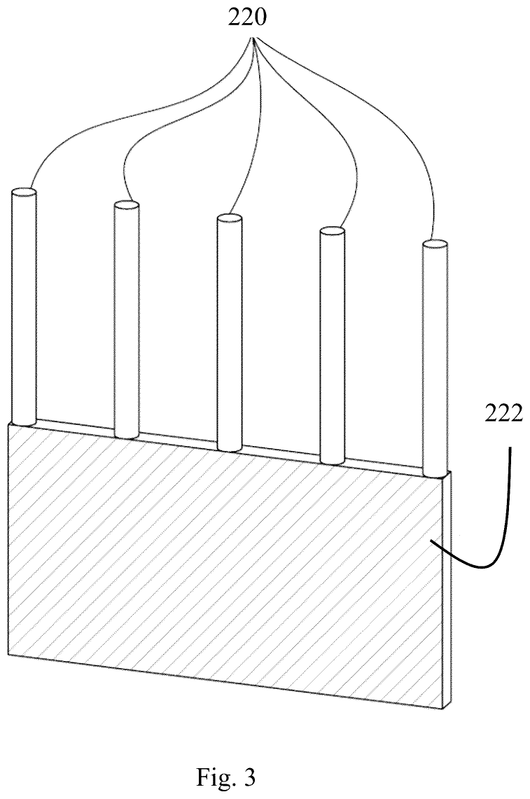

FIG. 3 shows a sound barrier system according to another embodiment of the invention. What is different between the sound barrier systems in FIGS. 1a-1b, and in FIG. 3, is that the five poles 220 shown in FIG. 2 are configured on top of a sound barrier screen 222. All five poles 220 extend along an upward direction and they are separated from each other equidistantly. The sound barrier screen 222 provides further noise protection for the upper floors of a high-rise buildings while maintaining high noise reduction for the lower floors. The overall height of the sound barrier system is therefore the sum of the height of a pole 220 and the height of the sound barrier screen 222. In one specific implementation, an overall height of the sound barrier screen 222 and the five poles 220 is more than 4 m.

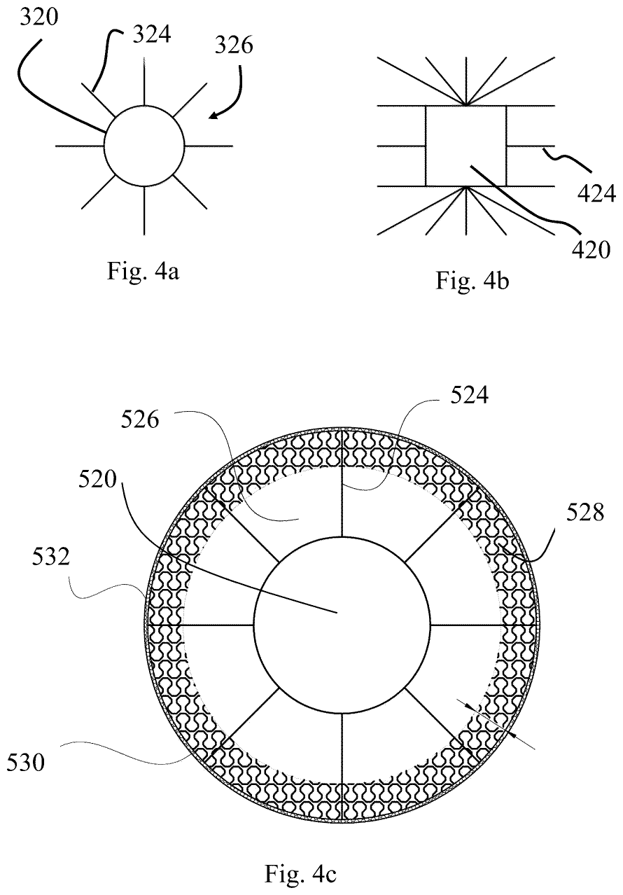

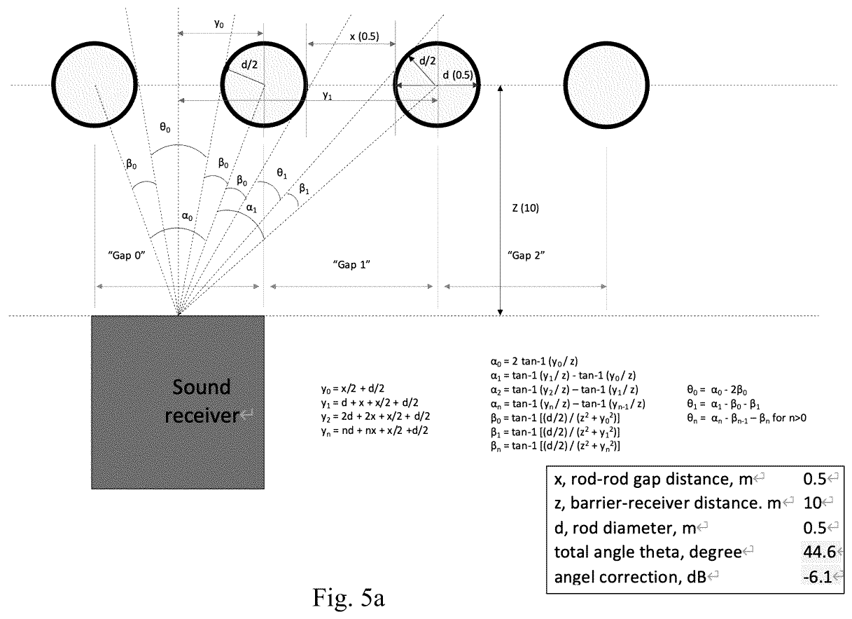

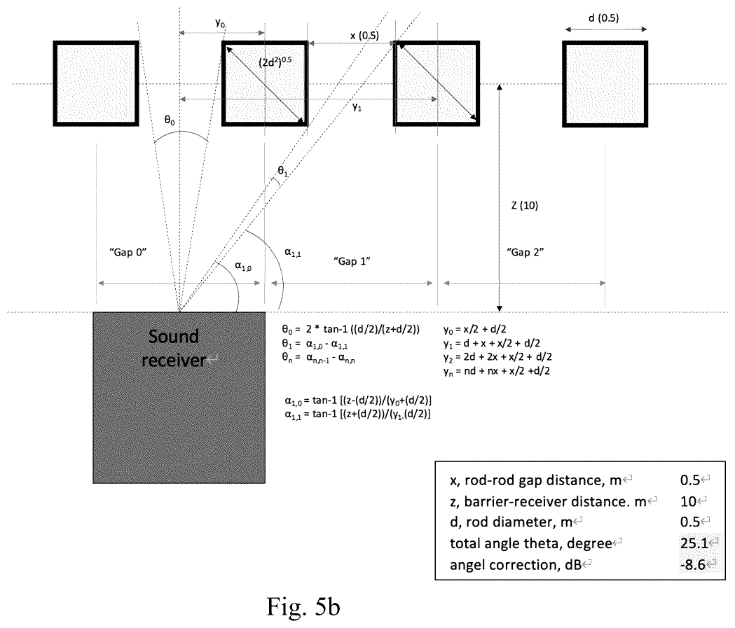

While poles in the sound barrier systems in FIGS. 1a-3 have a rod shape with a clean circumference, FIGS. 4a-4c show alternative designs of poles according to various embodiments of the invention. In FIG. 4a, the pole not only contains a pole body 320 that has a circular cross-sectional shape, but also a plurality of ribs 324 extending radially outward from the pole body 320. The ribs 324 are solid plates, and are connected to or formed as a single piece with the pole body 320. Between every two adjacent ribs 324 there is an angular gap 326 formed, the angular gap 326 being a vertical cavity that spans a certain angular distance. The angular gaps 326 extend along a vertical direction, and thus providing vertical cavities between the ribs 324. With the angular gaps 326 the ribs 324 behave like a N/4 quadratic diffuser. The angular gaps 326 are intended to prevent sound transmission between adjacent cavities. As shown in FIG. 4a, all the ribs 324 are evenly distributed on the circumference of the pole body 320. In the exemplary configuration shown in FIG. 4a, the angular gap 326 spans 45 degrees. In a specific implementation, the ribs 324 have a surface density of at least 4 kg/m².

FIG. 4b shows a different pole that has a pole body 420 with a square cross-sectional shape. There is a plurality of ribs 424 extending from the pole body 420, which extend from sides or corners of the square shape of the pole body 420. Some of the ribs 424 extend in parallel with each other and also are parallel with side(s) of the pole body 420. Some of the ribs 424 extend divergently from a single point at a side of the pole body 420. The ribs 424 are connected to or formed as a single piece with the pole body 420.

Turning to FIG. 4c, in another embodiment of the invention the pole contains a pole body 520 that has a circular cross-sectional shape, and a plurality of ribs 524 extending radially outward from the circumference of the pole body 520, similar to the configuration in FIG. 4a. However, compared to the configuration in FIG. 4a, at the far ends of the ribs 524, there is further configured a layer 528 of sound absorptive material. The layer 528 forms a circular shape and encloses the plurality of ribs 524 as well as the pole body 520 at the center. The layer 528 overlaps with a part of the each of the plurality of ribs 524 along its radial direction. In one specific implementation, the dimension of the layer 528 along the radial direction is equal to or larger than 40 mm.

At the exterior of the ribs 524 and the layer 528 there is a perforated metal sheet 530 that is curved in a circular shape and encloses the ribs 524 and the layer 528. The metal sheet 530 functions as a protective cover for the pole. One or more of the holes in the perforated metal sheet 530 is covered by an acoustic transparent membrane 532 which is configured at an internal surface of the perforated metal sheet 530. The acoustic transparent membrane 532 is used to protect the layer 528 of sound absorption material. In a specific implementation, the sound absorption material is rock wool or glass fiber wool. The acoustic transparent membrane 532 then prevents fiber migration from the sound absorption material of the layer 528. In a variation of the embodiment where the layer 528 is not configured, the acoustic transparent membrane 532 helps improve the cavity sound absorbing property of the angular gaps 526.

Each of the sound barrier systems shown in FIGS. 1a-4c provides one or more of the following mechanisms for reducing noise levels. 1) The individual poles partially block sound waves from passing through the sound barrier system. 2) Acoustic energy is absorbed when sound waves strike or pass through (or pass by) the absorbing surface of the poles. 3) The ribs of the poles diffract the direction of sound waves to large bending angles, away from noise-sensitive buildings. 4) Vertical cavities of the poles provide anti-phase reflected waves superimposed on the original sound waves passing through the gap.

A sample noise reduction calculation for Mechanism (1) is shown in FIGS. 5a and 5b. In FIG. 5a, multiple circular poles are configured in the sound barrier system similar to that in FIGS. 1a-1b, but in FIG. 5a there are four poles. In FIG. 5b, four square poles are configured in the sound barrier system. As showed on the calculation results in the figures, Mechanism (1) provides −6.1 dB noise reduction for circular poles (FIG. 5a) and −8.6 dB noise reduction for square poles (FIG. 5b). Mechanisms (2), (3) and (4) are estimated to provide an additional 1-3 dB (A) of noise reduction in total.

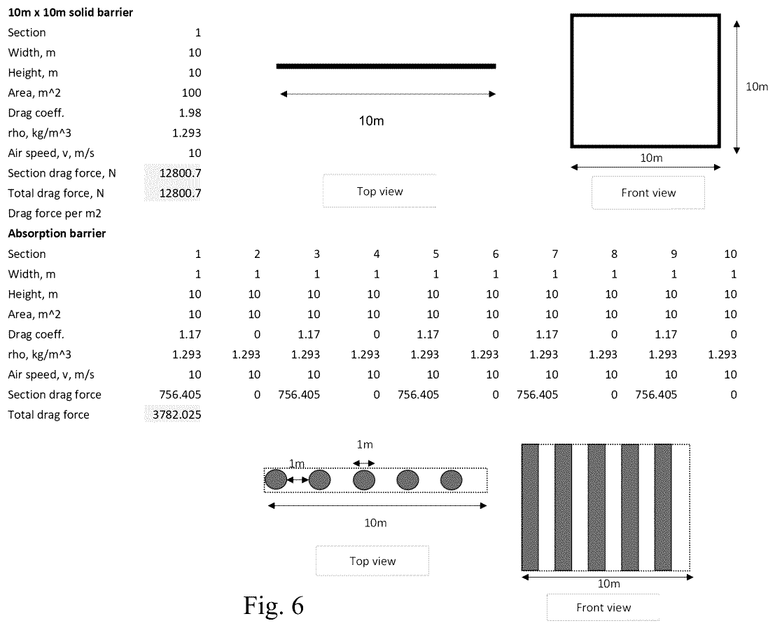

FIG. 6 shows the calculation of wind load reduction based on a conventional noise barrier screen and a sound barrier system that contains five circular poles respectively. The noise barrier screen has a width of 10 m and a height of 10 m. The five circular poles in the sound barrier system each has a diameter of 1 m and a distance of 1 m between each other. Based on the calculation results, the wind load force on the 5-poles noise barrier is only around 30% (or below) of that of the noise barrier screen.

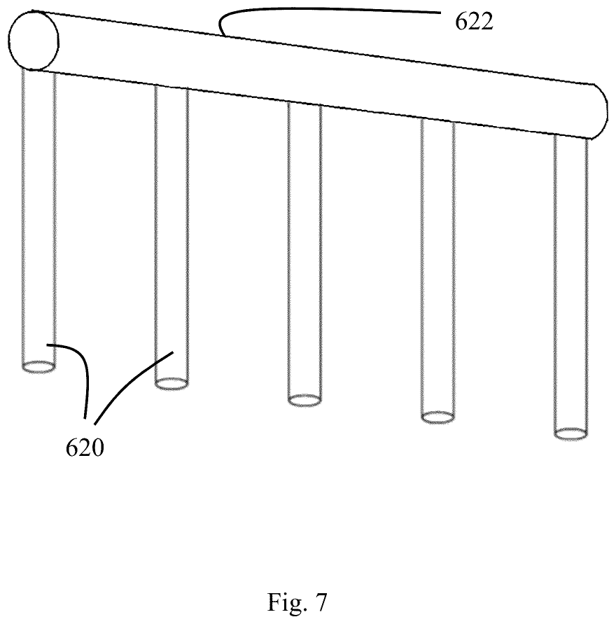

FIG. 7 shows a sound barrier system according to a further embodiment of the invention. A horizontal pole 622 is located above a plurality of vertical poles 620, and in particular top ends of the vertical poles 620 are connected to the horizontal pole 622. The internal configuration of the horizontal pole 622 may be similar to that shown in FIG. 4c. In some embodiments of the invention, the horizontal pole 622 is configured in an airfoil shape to reduce the horizontal wind drag force.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

For example, in various embodiments described above and illustrated in the figures, there are three, four or five poles that are separated from each other. However, the invention is not intended to be limited by the number of poles in a sound barrier system, as the number can be more or less than three. One could imagine that for a real freeway a large number of poles may be required to extend the sound barrier system to cover a long distance.

Similarly, the poles can take any shapes that meet design requirements. The above embodiments include circular or square cross-sectionally shaped poles, but one skilled in the art should realize that other quadrilateral shapes, triangles, hexagon, or any other closed shapes may be used for the cross section of poles. Depending on the design needs, the pole or pole body may be solid or hollow.

In certain embodiments, the poles in a sound barrier system may all have identical heights, or they may have different heights. In one example, heights of poles along a consecutive order may be 0.6 m, 1.2 m, 0.6 m, and so on.

What is claimed is:

1. A sound barrier system, comprising three or more poles aligned substantially along a line; every two adjacent ones of the three or more poles being separated from each other by a distance in the range of 0.4 m to 2 m, in order to reduce wind loads on the sound barrier system.

2. The sound barrier system of claim 1, wherein the three or more poles each extend along a vertical direction.

3. The sound barrier system of claim 1, wherein the three or more poles each has a length of more than 4 m.

4. The sound barrier system of claim 1, further comprises a sound barrier screen on top of which the three or more poles are mounted.

5. The sound barrier system of claim 4, wherein an overall height of the sound barrier screen and the three or more poles is more than 4 m.

6. The sound barrier system of claim 4, wherein at least one of the three or more poles comprises a pole body, and a plurality of ribs formed with or connected to a surface of the pole body, creating air cavities between the adjacent ribs.

7. The sound barrier system of claim 6, wherein the plurality of ribs each has a surface density of at least 4 kg/m².

8. The sound barrier system of claim 6, wherein the pole body has a circular cross-sectional shape; the plurality of ribs separated from each other evenly by an angular air cavity.

9. The sound barrier system of claim 8, wherein at least some of the air cavities are filled by a sound absorbing material.

10. The sound barrier system of claim 6, wherein the at least one of the three or more poles further comprises a layer of sound-absorbing material which encloses the plurality of ribs.

11. The sound barrier system of claim 10, wherein the layer of sound-absorbing material has a thickness of more than 40 mm.

12. The sound barrier system of claim 6, wherein the at least one of the three or more poles further comprises a perforated metal sheet which encloses the plurality of ribs.

13. The sound barrier system of claim 12, wherein a hole in the perforated metal sheet is covered by an acoustic transparent membrane configured at an internal surface of the perforated metal sheet.

14. The sound barrier system of claim 1, wherein at least one of the three or more poles has a quadrilateral cross-sectional shape.

15. The sound barrier system of claim 1, wherein the distance is in the range of 0.6 m to 1.2 m.

16. The sound barrier system of claim 2, wherein a horizontal pole is located above the three or more poles; top ends of the poles being connected to the horizontal pole.
